(19) United States
(12) Patent Application Publication
(10) Pub. No.: US 2010/0074346 A1
(43) Pub. Date: Mar. 25, 2010

(54) CHANNEL ESTIMATION IN OFDM RECEIVERS

(75) Inventors: Steven C. Thompson, San Diego, CA (US); Fernando Lopez de Victoria, San Carlos, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(73) Assignee: Acorn Technologies, Inc.

(21) Appl. No.: 12/235,420

(22) Filed: Sep. 22, 2008

(51) Int. Cl. H04L 27/28; H04L 27/06

(52) U.S. Cl. 375/260; 375/340

(57) ABSTRACT

An OFDM receiver includes a fast Fourier transform processor that receives signal samples and outputs frequency domain samples corresponding to a received symbol. A delay element receives sets of frequency domain samples outputs each of the sets of frequency domain samples following a predetermined delay interval. A frequency domain channel estimator receives frequency domain samples and derives channel estimates from each of the sets of frequency domain samples. A channel estimate queue stores a sequence of channel estimates provided by the channel estimator and provides the sequence to a weighted averaging element that outputs an averaged channel estimate. A frequency equalizer outputs an equalized set of frequency domain samples responsive to the delayed set of frequency domain samples and to the averaged channel estimate.

### BACKGROUND

1. Field of the Invention

The present invention relates to digital communication systems and, in particular, to systems that use orthogonal frequency domain multiplexing (OFDM) to achieve high information throughput over a wired or wireless communication link

2. Description of the Related Art

Orthogonal frequency domain multiplexing (OFDM) is a common modulation strategy for a variety of commercially significant systems, including for digital subscriber line (DSL) communication systems and a number of implementations of the various IEEE 802.xx standards for wireless communication systems with OFDM modulated signals. Often, an OFDM receiver will perform one or more functions that require parameter estimation to allow the receiver to acquire a signal and to improve signal quality before the receiver begins extracting bits.

OFDM receivers generally need to obtain signal timing information from a received signal to help identify the start of a symbol within the received signal. A symbol is a predetermined number N_{b} of bits uniquely mapped into a waveform over a predetermined, finite interval or duration. Each possible collection of bits is mapped to a unique signal according to the mapping or modulation strategy dictated by the OFDM strategy. Once an OFDM receiver determines when a symbol begins within the received signal, the receiver performs additional processing to improve the quality of the received signal. In the processing to improve signal quality, the receiver attempts to achieve a target bit error rate (BER), often by implementing a linear filter or equalizer to condition the input signal. The received signal can be significantly distorted by channel imperfections. Ideally, the equalizer corrects the distortions introduced by the channel completely so that the receiver can demodulate the signal with performance limited only by the noise level.

OFDM, unlikely most other modulation strategies commonly used in communication systems, can include two equalizers to improve signal quality: a time equalizer (TEQ) and a frequency equalizer (FEQ). Some OFDM applications such as DSL include a time equalizer while others, such as systems that implement current wireless standards, do not include a time equalizer. All practical OFDM receivers have a frequency equalizer. Whether a receiver includes a time equalizer or a frequency equalizer, the receiver needs to perform channel estimation to at least initially determine values of the equalizer coefficients before the equalizer can be used to improve the signal quality. Determining the equalizer coefficients by estimating the channel characteristics is done differently for time and frequency equalizers.

FIG. 1 illustrates conventional OFDM receiver circuitry that does not include a TEQ. More specifically, FIG. 1 shows the circuitry following analog-to-digital conversion of the signal (down converted to baseband) that produces the information signal s(n) shown as being input to the circuit. The signal s(n) is input 101 to a first processing element 110 that removes the cycle prefix (CP) from the signal s(n). A conventional OFDM transmitter adds a CP of length N_{CP}, which consists of the last N_{CP} samples, to a unique signal waveform of length N so that the digital signal that the transmitter converts to analog is of length N+N_{CP}. The initial step of the receiver's reverse conversion process then is to remove and discard the added cycle prefix N_{CP} samples. Following that step, a serial to parallel conversion element 120 organizes and converts the serial signal into parallel for further processing. The cycle prefix can be removed either before or after the serial to parallel conversion.

The parallel data output from the element 120 is provided to a fast Fourier transform (FFT) processor 130 that converts the time domain samples s(n) to a set of frequency domain samples Rᵢ(k) 131 for processing. The received OFDM signals are assumed to be corrupted by the channel, which is assumed for OFDM to introduce amplitude and phase distortion to the samples from each of the frequencies used in the OFDM system. The FEQ 150 applies an amplitude and phase correction specific to each of the frequencies used in the OFDM system to the various samples transmitted on the different frequencies. To determine the correction to be applied by the FEQ 150, the FEQ 150 needs an estimate of the channel's amplitude and phase variations from ideal at each frequency. In FIG. 1, the frequency domain channel estimate 140 element determines the channel estimate that is used by the FEQ 150.

FIG. 2 shows one example of a conventional OFDM channel estimator that could be used as the estimator 140 in FIG. 1. The FIG. 2 channel estimator typically uses a pilot tone sequence or other signal that has predictable characteristics such as known bits and carrier locations. The pilot tones are generally dictated by the relevant standards. The FIG. 2 estimator includes a pilot tone estimator 202 and an interpolator 204. The pilot tone estimator 202 estimates the channel at each of the Nₚ≦N pilot tones with the frequency-domain least squares (LS) calculation:

$${\hat{H}}_{i} ( k ) = \frac{{R}_{i} ( {k}_{p} )}{{X}_{i} ( {k}_{p} )} , {k}_{p} ∈ P \qquad ( 1 )$$

where P is the set of pilot tone indexes, Xᵢ(kₚ) is the pilot value at the pilot index kₚ, and Rᵢ(kₚ) are the fast Fourier transformed amplitude and phase values of the OFDM signal at the pilot index kₚ. The pilot tone estimator 140 generates an estimate of the expected OFDM signal at the pilot positions and the estimator compares those estimates to the received or actual OFDM signals at the pilot positions. The estimator then uses the above-referenced least squares calculation to determine a best estimate of the amplitude and phase errors for each of the transmission frequencies.

The set of pilot tone estimates feeds the interpolator 204. The interpolator is necessary to generate the estimates at all of the positions within the OFDM signal from the estimates at the positions of the pilot tones (indexes in P). The output of the interpolator is the channel estimate across the entire OFDM bandwidth and is provided to the FEQ150. Various interpolators are used and have been suggested including, for example, simple linear interpolators or more complex minimum mean square error interpolation based on Wiener filter design.

The frequency equalizer 150 receives the signals from the fast Fourier transform processor 130 and the channel estimates from the estimator 140 and equalizes the signal. The output of the equalizer 150 is provided to a parallel to serial element 160 that converts the parallel outputs of the equalizer to a serial signal that is then provided to the demodulator 170. The structure and function of the demodulator varies and generally correspond to a standard or particular OFDM communication scheme.

### SUMMARY OF THE PREFERRED EMBODIMENTS

Aspects of the present invention are embodied in an OFDM receiver that includes a Fast Fourier Transform (FFT) processor adapted to receive signal samples corresponding to signals received from a channel. The FFT processor outputs sets of frequency domain samples, with each set of frequency domain samples corresponding to a received symbol. A delay element is coupled to receive sets of frequency domain samples and to output each of the sets of frequency domain samples following a predetermined delay interval from the output of the set by the FFT processor. A frequency domain channel estimator is coupled to receive the sets of frequency domain samples and to derive corresponding channel estimates from each of the sets of frequency domain samples, the frequency domain channel estimator outputting a sequence of channel estimates corresponding to a sequence of the sets of frequency domain samples. A channel estimate queue stores the sequence of channel estimates. The receiver also includes a weighted averaging element coupled to the channel estimate queue to receive the sequence of channel estimates and to output an averaged channel estimate. A frequency equalizer is coupled to the delay element to receive a delayed set of frequency domain samples, the frequency equalizer coupled to the weighted averaging element to receive the averaged channel estimate, the frequency equalizer outputting an equalized set of frequency domain samples responsive to the delayed set of frequency domain samples and to the averaged channel estimate.

### BRIEF DESCRIPTION OF THE DRAWINGS

FIG. 1 schematically illustrates a conventional orthogonal frequency domain multiplexing (OFDM) receiver configuration.

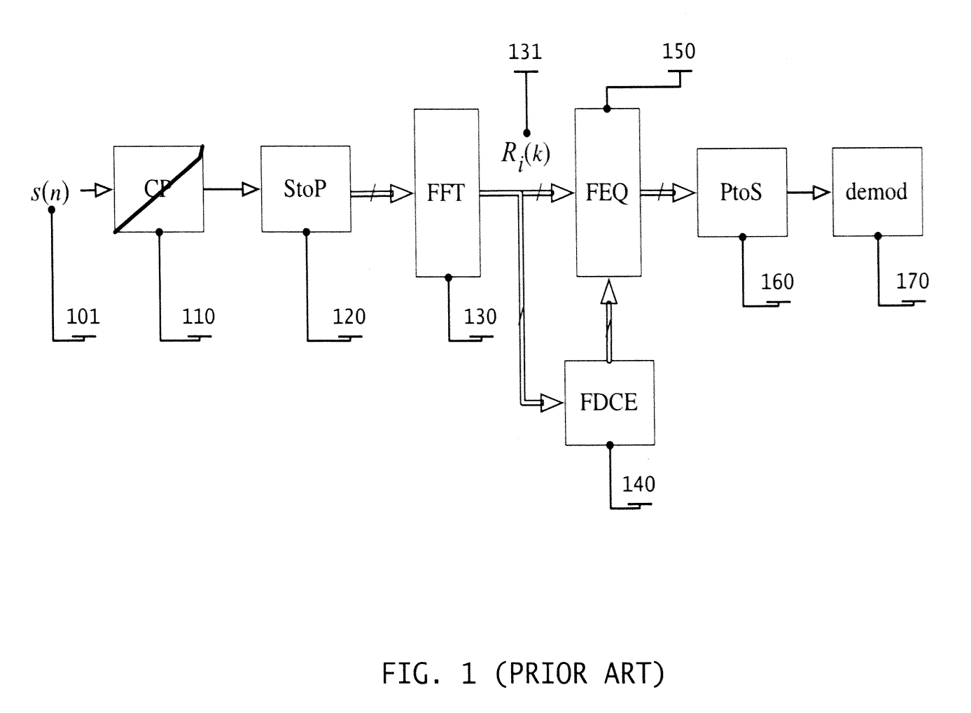

FIG. 2 schematically illustrates a conventional OFDM channel estimator.

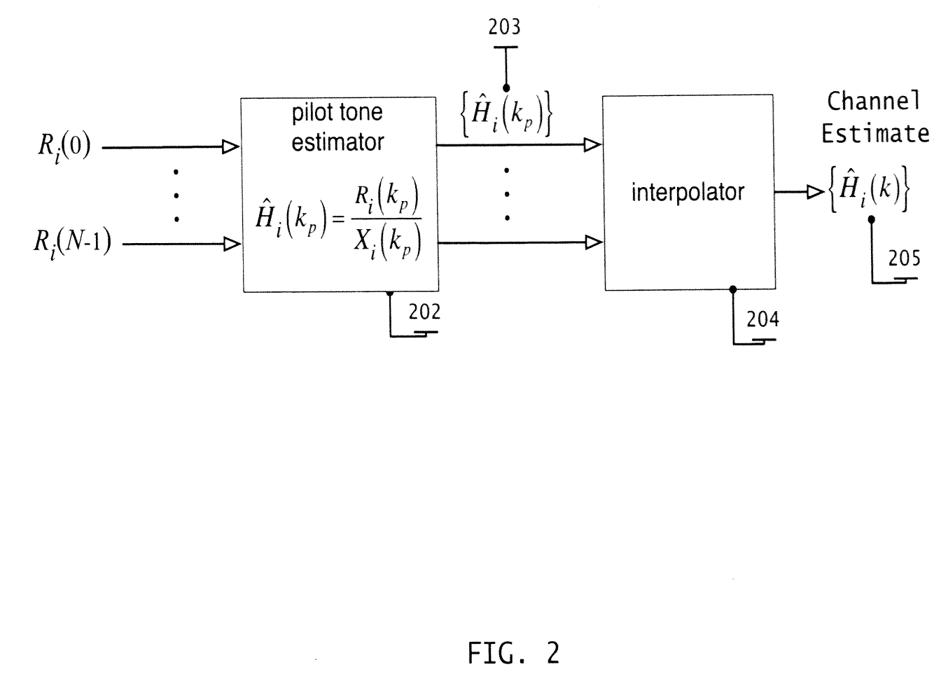

FIG. 3 schematically illustrates an OFDM receiver in accordance with the present invention.

FIG. 4 illustrates a weighted average channel estimation element for use in the FIG. 3 receiver.

### DETAILED DESCRIPTION OF THE PREFERRED EMBODIMENTS

The effectiveness with which conventional OFDM receivers operate is dependent on the quality of the channel estimate developed by the receiver. Often the performance of OFDM receivers is compromised by poor quality channel estimates, especially when the receiver is in motion with respect to the transmitter. Preferred implementations of the present invention provide improved frequency equalizer performance by improving on the channel estimate in OFDM receivers and systems. Preferred implementations may, for example, perform a weighted average over a number of channel estimates for neighboring symbols extracted from a received signal to improve on the channel estimates that are used to implement the frequency equalizer. The weighting function preferably is selected to optimize the channel estimation including, for example, a center weighted function for implementation of a mobile receiver. A variety of channel estimation strategies can be implemented and improved using aspects of the present invention.

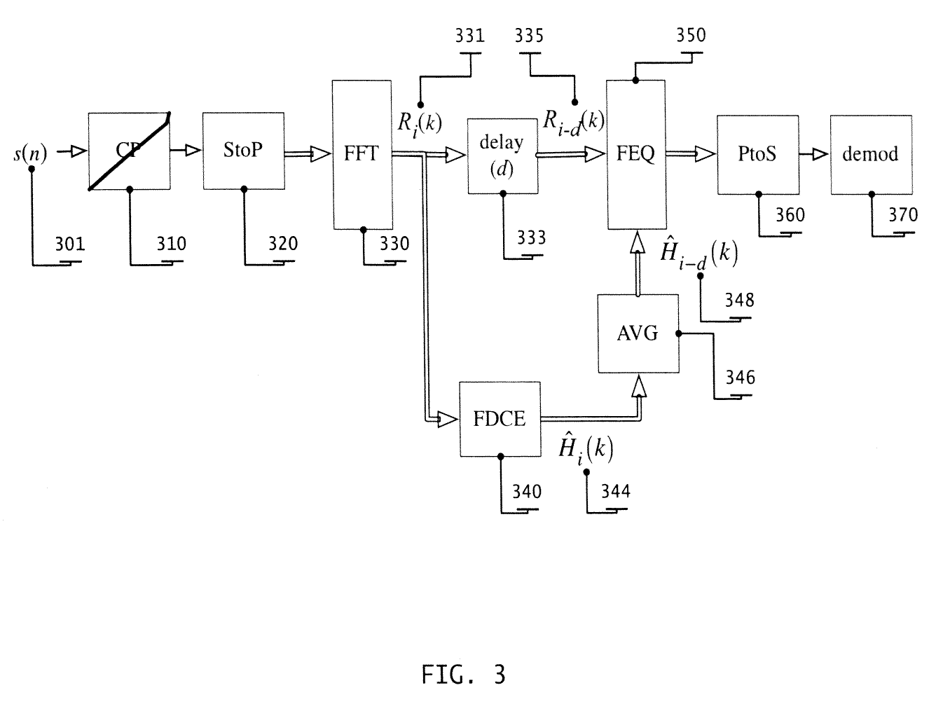

FIG. 3 illustrates a preferred implementation of an orthogonal frequency domain multiplexing (OFDM) receiver configuration according to the present invention. FIG. 3 shows the circuitry following analog-to-digital conversion of the signal (down converted to baseband) that produces the information signal s(n) 301 shown as being input to the circuit. The signal s(n) 301 is input to a first processing element 310 that removes the cycle prefix (CP) from the digital signal s(n). After removing the cycle prefix, a serial to parallel conversion element 320 organizes and converts the serial signal into parallel for further processing. Typically the conversion element 320 receives a set of samples at the sampling rate and provides them to a parallel register that can output the set of samples in a single clock cycle. The cycle prefix can be removed either before or after the serial to parallel conversion.

The parallel data output from the serial to parallel conversion element 320 is provided to a Fast Fourier Transform (FFT) processor 330 that converts the time domain samples to a set of frequency domain samples for processing, the OFDM symbol Rᵢ(k) 331. Each of the symbols output by the FFT processor 331 is provided to a delay element 333, which delays the symbol by a delay of d-symbols in duration and provides the delayed symbol R_{i-d}(k) 335 to a frequency equalizer (FEQ) 350. The frequency equalizer may be an OFDM frequency equalizer that applies a phase and amplitude correction specific to each active frequency in the FFT.

The FFT processor 331 also outputs its symbols to a frequency domain channel estimate (FDCE) element 340, which performs channel estimation based on the i^{th} received frequency-domain symbol Rᵢ(k) and outputs corresponding channel estimate Ĥᵢ(k) 344. That is, the output of the FFT processor 331 provides samples in parallel to both of the delay element 333 and the channel estimator 340. The channel estimator 340 may for example, use a pilot tone sequence or other component of the OFDM signal that has predictable characteristics such as known bits and carrier locations. For most OFDM implementations, the pilot tone locations are dictated by the relevant standards.

Preferred implementations of an estimator include a pilot tone estimator that estimates the channel at each of the Nₚ≦N pilot tones with the frequency-domain least squares (LS) calculation:

$${\hat{H}}_{i} ( k ) = \frac{{R}_{i} ( {k}_{p} )}{{X}_{i} ( {k}_{p} )} , {k}_{p} ∈ P \qquad ( 2 )$$

where P is the set of pilot tone indexes, Xᵢ(kₚ) is the pilot value at the pilot index kₚ, and Rᵢ(kₚ) are the fast Fourier transformed sample values of the OFDM signal at the pilot index kₚ. The pilot tone estimator generates an estimate of the expected OFDM signal at the pilot positions and the estimator compares those estimates to the received or actual OFDM signals at the pilot positions. The estimator then uses the least squares calculation of equation (2) to determine a best estimate of the amplitude and phase errors for each of the transmission frequencies. These estimates are provided to an interpolator that generates the estimates at all of the positions within the OFDM signal from the estimates at the positions of the pilot tones. Various interpolators might be used including, for example, simple linear interpolators or more complex minimum mean square error interpolation based on Wiener filter design. The output of the interpolator is the channel estimate Ĥᵢ(k) 344 corresponding to an input symbol and is the output from the frequency domain channel estimate element 340.

The channel estimator 340 provides the channel estimate Ĥᵢ(k) 344 to the averaging element 346, which preferably performs a weighted average of channel estimates corresponding to symbols preceding and following the symbol for which the channel estimate is being processed. The time necessary to provide the channel estimate from element 340 and to collect channel estimates and perform the weighted averaging in element 346 determines the delay to be generated by the delay element 333. Generally the delay d is empirically determined based on the averaging strategy and the implementation details of the estimator and averaging circuits. The weighted averaging element 346 provides an averaged channel estimate to the frequency equalizer 350, which applies a phase and amplitude correction to the samples of the symbol according to the transmission frequency used for those samples.

The frequency equalizer 350 receives the delayed fast Fourier transformed signals output by the delay element 333 and the channel estimates from the averaging element 346 and equalizes the signals. The output of the equalizer 350 is provided to a parallel to serial conversion element 360 that converts the parallel outputs of the equalizer to a serial signal that is then provided to the demodulator 370. The structure and function of the demodulator varies and generally correspond to a standard or particular OFDM communication scheme. The demodulator 370 demodulates the signal and outputs the transmitted information.

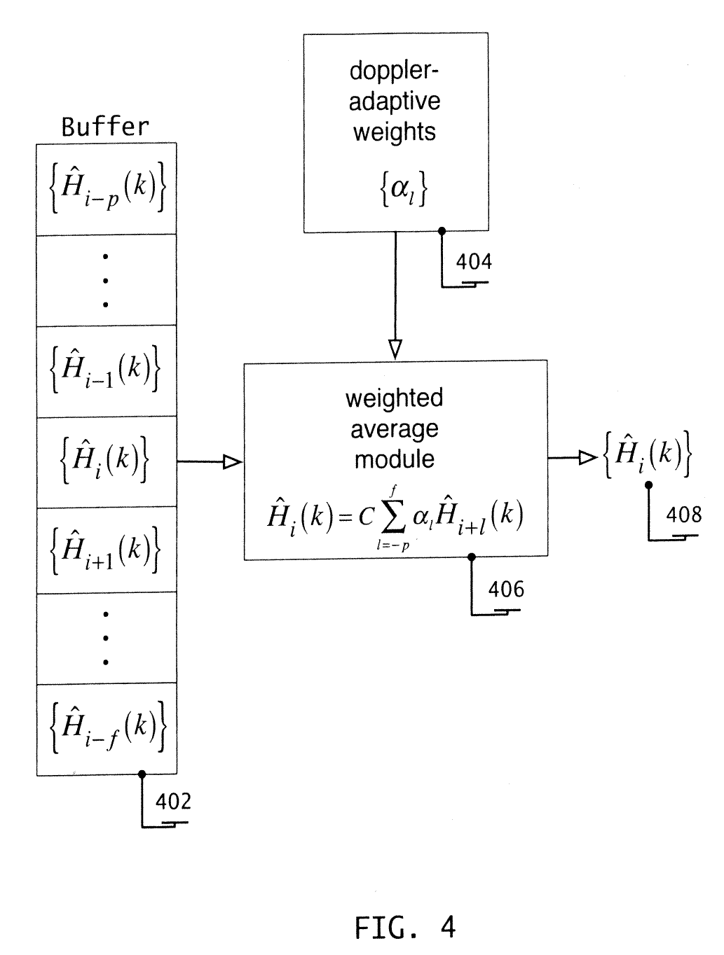

FIG. 4 illustrates a preferred implementation of a channel estimate averaging element 346 that can be used in the FIG. 3 receiver. The channel estimate averaging element of FIG. 4 includes a buffer or queue 402 that stores the p past channel estimates that preceded the current symbol, stores the channel estimate for the current symbol and stores the f future channel estimates that follow the current symbol. The channel estimate averaging element preferably includes a register or a second buffer 404 that stores a set of estimate weights al to be used in performing the averaging operation. The channel estimate averaging element also includes a weighted averaging module 406. The preferred weighted averaging module 406 receives a sequence of channel estimates Ĥᵢ(k) from the buffer 402 and a corresponding sequence of estimate weights α₁ and generates an averaged channel estimate according to equation (3):

$${\hat{H}}_{i} ( k ) = C {\sum }_{l = - p}^{f} {α}_{l} {\hat{H}}_{i + l} ( k ) . \qquad ( 3 )$$

This is a preferred averaging strategy and others may be implemented. In equation (3), the constant C is a normalizing constant used to keep the channel estimate power unchanged.

As a simple example, the averaging may be performed over the preceding symbol's channel estimate (p=1), the current symbol's channel estimate and the following symbol's channel estimate (f=1). For this “nearest neighbor” averaging, equal weights can be used for each of the weights α₁ and the constant C=⅓. This example of nearest neighbors with equal weights works well and is presently preferred for a stationary or static channel. Larger averaging windows provide better channel estimates and can approach an ideal channel estimate, but there are diminishing improvements for successively larger windows. The computational simplicity of the equal weights. nearest neighbor averaging allows the system to be practically implemented. Simulations showed that the simple, equal weighting, nearest neighbor averaging strategy produces a useful level of improvement of 2 dB for a 30 km/h time varying channel.

For a time-varying channel, for example caused by Doppler effects associated with a mobile receiver, the channel is expected to change, sometimes by a large amount. As a general rule, it is preferred to use a center weighted channel weighting strategy for the channel estimate averaging element, where the current symbol channel estimate has the highest weighting. An example of a simple weighting for use with a time-varying channel is to select nearest neighbor averaging with weights of α₋₁=1, α₀=2, and α₁=1, with C=¼. This weighting has the advantage of providing averaging while diminishing the contribution of the more out of date channel estimates. In more sophisticated systems, the weighting for time-varying channels can be selected empirically to or have weightings that vary with the extent of Doppler.

For any of the weighting systems, there are needed adaptations of the technique for the edge instances of the symbols, since for the earliest symbol there will not be a preceding symbol and for the last symbol there will not be a succeeding symbol. For this situation, the average is taken only over the current symbol and the existing nearest neighbor with equal weightings for static channel implementations. For a time-varying channel, edge symbol weighting is preferably adapted to weight the current symbol at twice the weighting of the existing nearest neighbor symbol channel estimate. For this case, the weights might be weights of α₋₁=- - - , α₀=2, and α₁=1, with C=⅓ or weights of α₋₁=1, α₀=2, and α₁=- - - , with C=⅓, as appropriate. For situations in which a different weighting strategy is used, that strategy is adapted for the edge symbols in a similar way.

Simulations show that it is more advantageous, by approximately 0.2 dB, to perform averaging after interpolation as illustrated in FIGS. 3 and 4 as compared to performing averaging of channel estimates first and then performing interpolation. This is illustrated by the case of linear interpolation, where averaging followed by interpolation exhibits the full degrading effects of linear interpolation. For the preferred interpolate then average implementation, the degrading effects of linear interpolation are reduced by the subsequent averaging.

Note here that the receiver illustrated in FIG. 3 is illustrated as not including a time domain equalizer. Presently preferred implementations need not include a time domain equalizer, but it should be understood that aspects of the present invention can be implemented with both a frequency domain equalizer and a time domain equalizer. Under such circumstances, the weighted averaging strategy for estimating the channel might be used in both types of equalizers.

The present invention has been described with reference to the drawings and to certain preferred embodiments thereof. Those of ordinary skill will appreciate that various modifications and alterations of the illustrated and preferred embodiments could be made within the teachings of the present invention. Accordingly, the present invention is not to be limited to the specific illustrated embodiments or the described preferred embodiments but instead the present invention is defined by the claims, which follow.

What is claimed:

1. An OFDM receiver, comprising:
a Fast Fourier Transform processor adapted to receive signal samples corresponding to signals received from a channel, the Fast Fourier Transform processor outputting sets of frequency domain samples, each set of frequency domain samples corresponding to a received symbol;
a delay element coupled to receive sets of frequency domain samples and to output each of the sets of frequency domain samples following a predetermined delay interval from the output of the set by the Fast Fourier Transform processor;
a frequency domain channel estimator coupled to receive the sets of frequency domain samples and to derive corresponding channel estimates from each of the sets of frequency domain samples, the frequency domain channel estimator outputting a sequence of channel estimates corresponding to a sequence of the sets of frequency domain samples;
a channel estimate queue storing the sequence of channel estimates;
a weighted averaging element coupled to the channel estimate queue to receive the sequence of channel estimates and to output an averaged channel estimate; and
a frequency equalizer coupled to the delay element to receive a delayed set of frequency domain samples, the frequency equalizer coupled to the weighted averaging element to receive the averaged channel estimate, the frequency equalizer outputting an equalized set of frequency domain samples responsive to the delayed set of frequency domain samples and to the averaged channel estimate.

2. The receiver of claim 1, wherein the predetermined delay is sufficient to cause the averaged channel estimate and the delayed set of frequency domain samples to correspond to a same received symbol.

3. The receiver of claim 1, wherein the weighted averaging element applies equal weights for averaging channel estimates for a stationary receiver.

4. The receiver of claim 1, wherein the frequency domain channel estimator includes an interpolator that receives channel estimates at a first interval and generates channel estimates at a second interval, and wherein the weighted averaging element is coupled to receive the channel estimates at the second interval.

5. The receiver of claim 4, wherein the first interval corresponds to positions of pilot signals within an OFDM signal.

6. The receiver of claim 1, wherein the weighted averaging element applies center-weighted weights for averaging channel estimates.
